(19) United States
(12) Patent Application Publication
(10) Pub. No.: US 2019/0312416 A1
(43) Pub. Date: Oct. 10, 2019

(54) High-voltage or medium-voltage switching system

(71) Applicant: Rail Power Systems GmbH, Munchen (DE)

(72) Inventor: Matthias Schmalz, Gründau (DE)

(21) Appl. No.: 16/375,883

(22) Filed: Apr. 5, 2019

(30) Foreign Application Priority Data
Apr. 10, 2018 (EP) 18 166 686.8

(51) Int. Cl. H02B 13/02; H01H 31/00; H01H 3/40; H01H 19/14

(52) U.S. Cl. CPC H02B 13/02; H01H 19/14; H01H 3/40; H01H 31/003

(57) ABSTRACT

The invention relates to a high-voltage or medium-voltage switching system comprising at least one switching unit 1, which has a rotary switch 1A and a drive unit 10 for rotating the rotary switch, the drive unit 1 having a drive motor 9. The drive unit 1 has an actuation unit for actuating the drive motor 9, which is formed in such a way that when the drive motor 9 is operated the rotary switch 1A adopts a plurality of predetermined switching positions. The actuation unit has a switching member 17 for switching the drive motor 9 on and off and a rotatable body 16, as well as an activation element 18, which cooperates with the rotatable body 16, for activating the switching member 17. The activation element 18 and the switching member 17 ensure, together with the rotatable body 16, that the drive motor 9 is only switched on and off in particular rotational positions which correspond to particular switching positions of the switching unit 1, in such a way that the different switching positions can be approached highly precisely.

### BACKGROUND OF THE INVENTION

### 1. Field of the Invention

The invention relates to a high-voltage or medium-voltage switching system comprising at least one switching unit, which has a rotary switch and a drive unit for rotating the rotary switching, the drive unit having a drive motor.

### 2. Description of the Prior Art

High-voltage and medium-voltage switching systems may comprise various switching devices, including for example power switches, grounding switches and disconnect switches, which can adopt various switching positions. A power switch may be switched on or off, a grounding switch may adopt a disconnect or a grounding position, and a disconnect switch may adopt an operational or a grounding position. These switching devices may therefore each adopt two switching positions.

Combined disconnect/grounding switches are also known, which can adopt three different switching positions, namely an operational position, a disconnect position and a grounding position. Switching devices of this construction are also referred to as three-position switches. Special switches such as five-position switches can adopt five switching positions, namely also various grounding positions as well as an operational and a disconnect position. In a switching system, a five-position switch can ground the cable outlet, the busbar, or the cable outlet and the busbar.

DE 10 2007 004 950 A1 (U.S. Pat. No. 7,679,019) describes a switching system which comprises a power switch or load-break switch, a disconnect switch and a grounding switch, the switches forming a structural unit. The known switching unit is distinguished by low isolating distances and a particularly compact construction. The switching unit is formed as a rotary switch, which can adopt five switching positions. In one rotational position of the rotary switch an electrical connection between the terminal contacts of the power switch or load switch and of the grounding switch can be established, in one rotational position an electrical connection between the terminal contacts of the power switch or load switch, of the disconnect switch and of the grounding switch can be interrupted, in one rotational position an electrical connection between the terminal contacts of the power switch or load switch and of the disconnect switch can be established, in one rotational position an electrical connection between the terminal contacts of the disconnect switch and of the grounding switch can be established, and in one rotational position an electrical connection between the terminal contacts of the power switch or load switch, of the grounding switch and of the disconnect switch can be established. The rotary switch has a switching contact arrangement which is rotatable about a central axis. So as to be able to operate a switching unit of this type from a control center, a drive unit is required. However, a drive for rotating the switch contact arrangement is not described in DE 10 2007 004 950 A1 (U.S. Pat. No. 7,679,019).

Very high requirements are placed on the drive unit of an electrical switching unit of the aforementioned construction in practice. It should be possible to operate the drive unit highly reliably over a long time period. At the same time, it should be ensured that the switching contact arrangement of the rotary switch adopts the specified rotational positions, in which the contacts of the switching contact arrangement are orientated exactly to the corresponding contacts of the individual switches.

### SUMMARY OF THE INVENTION

The object of the invention is to provide a high-voltage or medium-voltage switching system comprising a switching unit which is of a compact construction and can be operated highly reliably over as long a time period as possible largely without maintenance, in particular a drive unit for a switching unit of a high-voltage or medium-voltage switching system which makes largely maintenance-free operation of a switching unit possible highly reliably over a relatively long time period.

This object is achieved according to the invention by the features of the independent claims. The subject matter of the dependent claims relates to various advantageous embodiments of the invention.

The high-voltage or medium-voltage switching system comprises at least one switching unit, which has a rotary switch and a drive unit for rotating the rotary switch, the drive unit having a drive motor.

The drive unit according to the invention comprises an actuation unit for actuating the drive motor, which is formed in such a way that when the drive motor is operated the rotary switch adopts a plurality of predetermined switching positions. The actuation unit of the drive unit according to the invention has a switching member for switching the drive motor on and off and a rotatable body, as well as an activation element, which cooperates with the rotatable body, for activating the switching member.

The drive motor is preferably an electric drive motor, and the switching member is preferably an electrical switch. The drive train preferably comprises at least one transmission, in such a way that the electric motor can apply the torque required for activating the switching unit. Instead of an electric drive, however, it is also possible in principle to provide a pneumatic or hydraulic drive. In an embodiment of this type, the switching member may be a valve.

The rotatable body is formed in such a way that, in predetermined rotational positions of the rotatable body, which correspond to the predetermined switching positions of the rotary switch, the activation element is engaged with the rotatable body, in such a way that the activation element adopts a first position, in which the switching member adopts a first switching state, and outside the predetermined rotational positions of the rotatable body it is disengaged from the rotatable body, in such a way that the activation element adopts a second position, in which the switching member adopts a second switching state.

The switching member, preferably the electrical switch, may serve to interrupt a circuit which includes the electric motor. The first switching state is preferably a switching state in which the electrical switch is open, in such a way that the drive motor is switched off. In the second switching state, the switching member is preferably closed, in such a way that the drive motor is switched off. However, the motor control system may also provide switching on the motor when the switch is open and switching off the motor when the switch is closed.

The activation element and the switch ensure, together with the rotatable body, that the motor is only switched on and off in particular rotational positions which correspond to particular switching positions of the switching unit, in such a way that the different switching positions can be approached highly precisely.

Using the above arrangement, a motor control system can be provided in which the electric motor is switched off as long as the activation element is engaged with the rotatable body. When the activation element is disengaged from the rotatable body, the rotary switch is rotated by the electric motor until the activation element is engaged with the rotatable body again. As a result of the special formation of the rotatable body, the predetermined switching positions can thus be defined.

A preferred embodiment of the switching system according to the invention provides that the actuation unit has a release unit for releasing the activation element of the switching member, the release unit being formed in such a way that the activation element can be brought from a position in which the activation element is engaged with the rotatable body into a position in which the activation element is disengaged from the rotatable body.

The actuation unit of the switching unit is formed in such a way that, to rotate the rotary switch from one switching position into another switching position, the release unit is actuated, causing the activation element of the switching member to be disengaged from the rotatable body, in such a way that the drive motor is switched on, the rotary switch being rotated by the drive motor until the activation element of the switching member comes into engagement with the rotatable body, in such a way that the drive motor is switched off.

The release unit thus makes it possible to initiate a switching process in which the rotary switch can only rotate until another predetermined switching position is reached in which the activation element comes into engagement with the rotatable body again, causing the drive motor to be switched off again.

The rotatable body can be configured differently. All that is decisive is that the activation element is only engaged with the rotatable body in predetermined rotational positions, which correspond to the switching positions of the rotary switch.

A preferred embodiment provides that the rotatable body is a disc which is positioned on a rotatably mounted driven shaft of the drive unit. In a particularly preferred embodiment, the disc has recesses arranged circumferentially distributed on the circumferential face, and the activation element of the switching member is formed as a latch which engages in the recesses in the predetermined rotational positions of the disc which correspond to the predetermined switching positions. However, the recesses do not have to be provided on the circumferential face of the disc, but may also be provided on one or both side faces. In this context, recesses are understood to mean any formations of the disc which make it possible for another part to engage, for example notches, toothings, holes, drill holes etc.

To determine the rotational position of the rotatable body, preferably the disc, the actuation unit preferably has a position determination means comprising a plurality of switching position sensor elements. The rotatable body is formed in such a way that, in the predetermined rotational positions of the rotary body which correspond to the predetermined switching positions of the rotary switch, individual sensor elements are engaged with the rotatable body depending on the rotational position. As a result, the sensor elements make coding for the different switching positions possible, in which context each sensor element can detect a binary state, in other words is engaged with or disengaged from the disc. The position detection means may have electrical switches or buttons which can be activated by the switching position sensor elements and which can be opened or closed by the sensor elements in such a way that the position can be detected in a simple manner using an electrical evaluation circuit.

In a particularly preferred embodiment, the disc has recesses arranged circumferentially distributed on a side face, the switching position sensor elements engaging in the corresponding recesses in the predetermined rotational positions of the disc which correspond to the predetermined switching positions of the rotary switch. In this connection, recesses are again understood to mean any formations of the disc which make it possible for another part to engage, for example notches, toothings, holes, drill holes etc.

To protect the operating means from faulty operation and to increase safety in the event of a fault, the actuation unit may have an end position switching means which prevents continued rotation of the rotary switch in any case where, after the release of the activation element, the drive unit is not stopped in the desired rotational position by the previously released activation element coming into engagement with the rotatable body again in such a way that the drive motor is switched off. The end position switching means may have an end position sensor element for each end position, the rotatable body being formed in such a way that in a predetermined end position the sensor element is engaged with the rotatable body. The disc preferably has recesses arranged circumferentially distributed on a side face, the end position switching means having switches or buttons which can be activated by the end position sensor elements. These switches may be connected into the circuit which includes the electric drive, in such a way that the drive is switched off in the end position. In the direction of rotation of the disc, the end position may be immediately after the rotational position corresponding to the switching position of the rotary switch, in such a way that the motor is switched off immediately.

The drive unit and the switching unit may form assemblies (modules) which are physically separated from one another in the switching system. The rotatable body can be coupled to the rotary switch of the switching unit using a traction drive or using rods or levers. To transmit the relatively high torques which are required to switch switching devices comprising vacuum switching chambers, the driven shaft of the drive unit may for example be connected using a traction drive, preferably a chain or a drive shaft, to a drive shaft which is connected to a switch contact arrangement, which is rotatable about a central axis, of the rotary switch.

The drive according to the invention may be used for completely different switching units, which have different switching devices, so as to establish electrical connections, for example between contacts of a power switch or load switch, of a disconnect switch and of a grounding switch, in the predetermined rotational positions of the rotatable body which correspond to the predetermined switching positions of the rotary switch.

The rotary switch of the switching unit may be formed in such a way that in one rotational position an electrical connection between the terminal contacts of the power switch or load switch and of the grounding switch is established, and/or in one rotational position an electrical connection between the terminal contacts of the power switch or load switch, of the disconnect switch and of the grounding switch is interrupted, and/or in one rotational position an electrical connection between the terminal contacts of the power switch or load switch and of the disconnect switch is established, and/or in one rotational position an electrical connection between the terminal contacts of the disconnect switch and of the grounding switch is established, and/or in one rotational position an electrical connection between the terminal contacts of the power switch or load switch, of the grounding switch and of the disconnect switch is established. The switching unit may for example be a three-position switch or a five-position switch. For example, the drive unit may be used for driving the switch contact arrangement referred to as the “central switch” of the electrical switching system described in DE 10 2007 004 950 A1 (U.S. Pat. No. 7,679,019).

### BRIEF DESCRIPTION OF THE DRAWINGS

Hereinafter, two embodiments of the invention are described in detail, with reference to the drawings, in which:

FIG. 1A shows a first switching position of the switching unit of the high-voltage or medium-voltage switching system,

FIG. 1B shows a second switching position of the switching unit of the high-voltage or medium-voltage switching system,

FIG. 1C shows a third switching position of the switching unit of the high-voltage or medium-voltage switching system,

FIG. 1D shows a fourth switching position of the switching unit of the high-voltage or medium-voltage switching system,

FIG. 1E shows a fifth switching position of the switching unit of the high-voltage or medium-voltage switching system,

FIG. 2 is a perspective drawing of the drive unit of a first embodiment having three switching positions,

FIG. 3 is a plan view of the rotatable disc of the actuation unit of the drive unit of FIG. 2,

FIG. 4 is a drawing of the rotatable disc of the actuation unit to illustrate the functionality of the position detection means and of the end position switching means,

FIG. 5 is a perspective drawing of the drive unit of a second embodiment having five switching positions,

FIG. 6 is a plan view of the rotatable disc of the actuation unit of the drive unit of FIG. 5, and

FIG. 7 is a drawing of the rotatable disc of the actuation unit for illustrating the functionality of the position detection means and of the end position switching means.

### DETAILED DESCRIPTION

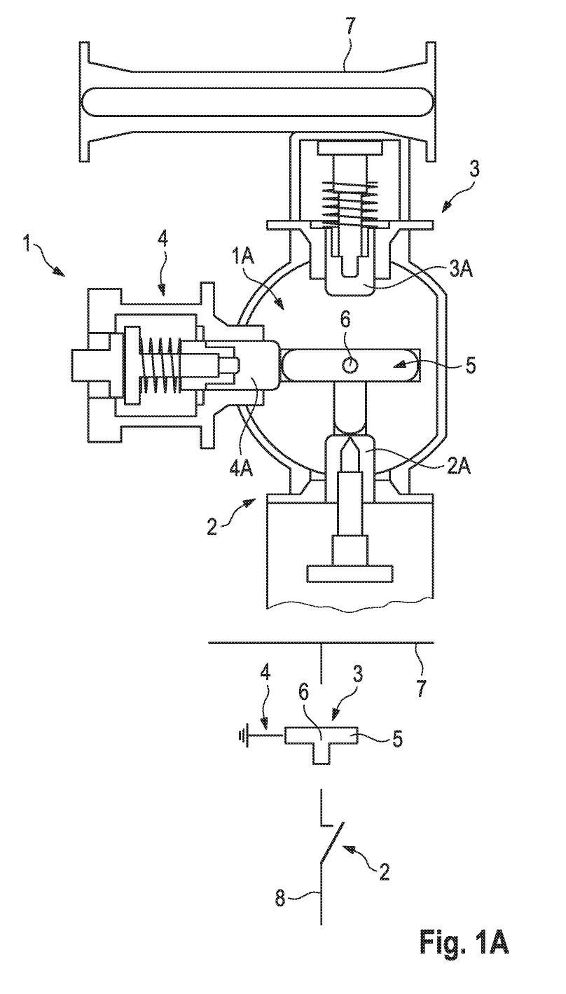

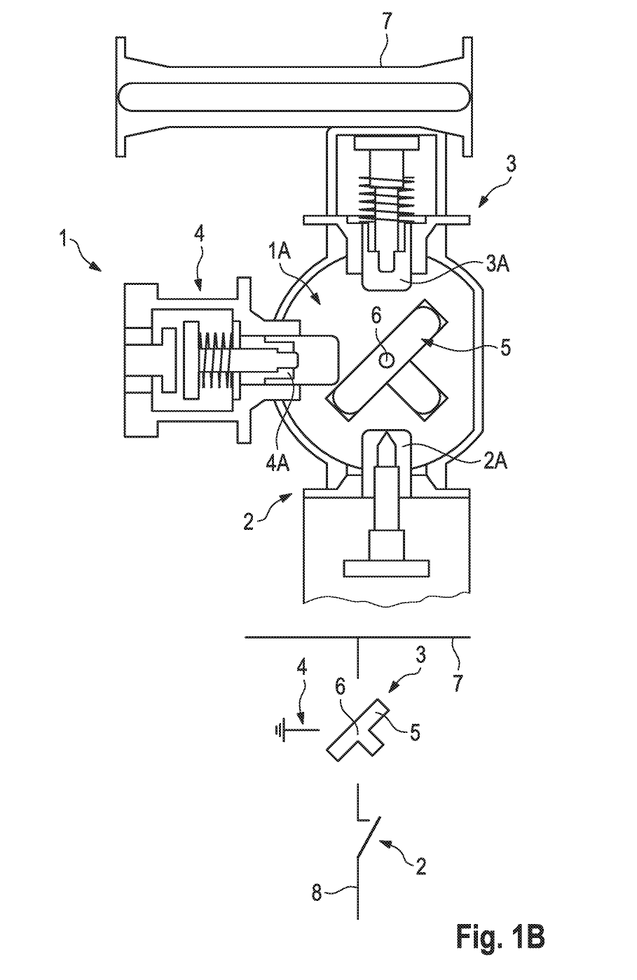

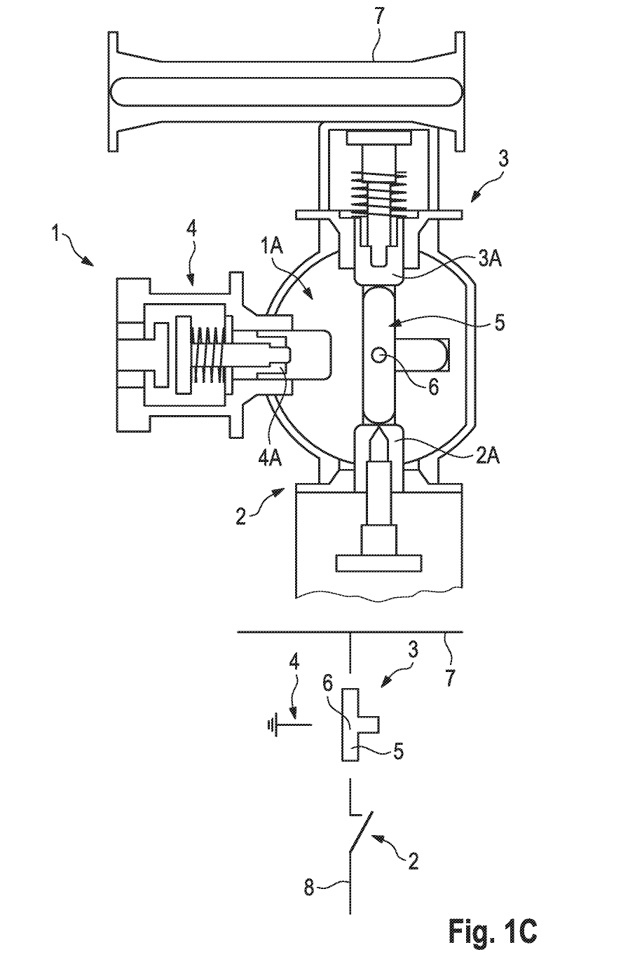

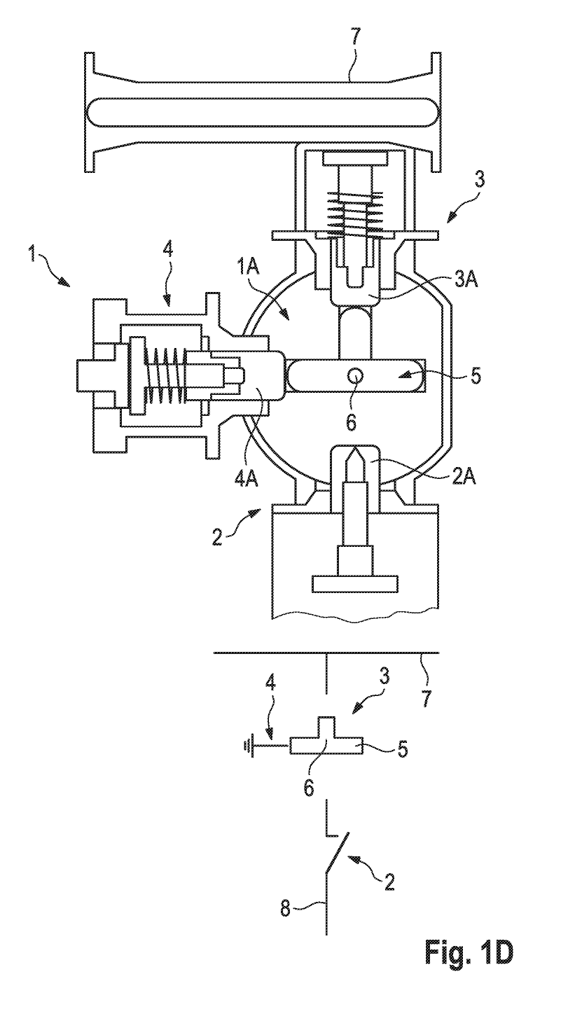

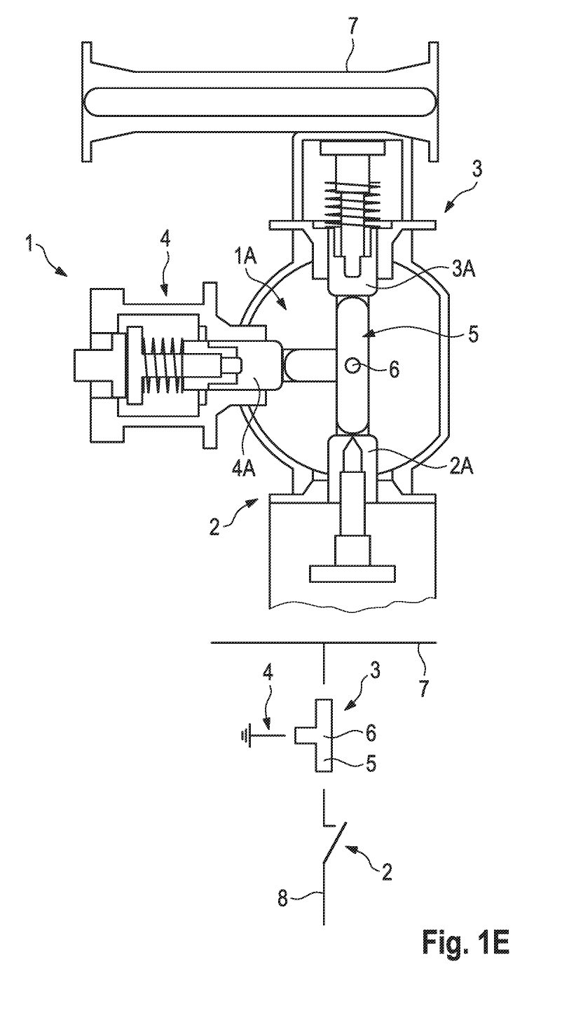

FIG. 1A to lE are highly simplified schematic drawings of an electrical switching system, which is described in detail in DE 10 2007 004 950 A1 (U.S. Pat. No. 7,679,019), to which reference is hereby explicitly made and which is incorporated herein by reference. FIG. 1A to lE show the individual switching positions of the switching unit. The switching unit 1 has a rotary switch 1A, which comprises a power switch 2 or load disconnect switch (merely outlined), a disconnect switch 3 and a grounding switch 4. The individual switching positions can be adopted by rotating a switching contact arrangement 5, referred to in DE 10 2007 004 950 A1 (U.S. Pat. No. 7,679,019) as a central switch. The switching contact arrangement 5 is connected to a drive shaft 6, which is mounted rotatably about a central axis. The switching unit 1 may also be referred to as a switchgear.

FIG. 1A shows a switching position (angle of rotation 0°) in which an electrical connection between the terminal contacts 2A of the power switch 2 or load disconnect switch and the terminal contacts 4A of the grounding switch 4 can be established so as to ground the cable outlet 8.

FIG. 1B shows the disconnect position (angle of rotation 45°), in which the electrical connection between the terminal contacts 2A, 3A, 4A of the power switch 2 or load switch, of the disconnect switch 3 and of the grounding switch 4 is interrupted.

FIG. 1C shows the operating position (angle of rotation 90°), in which an electrical connection between the terminal contacts 2A of the power switch 2 or load disconnect switch and the terminal contacts 3A of the disconnect switch 3 can be established so as to connect the busbar 7 to the cable outlet 8.

FIG. 1D shows a switching position (angle of rotation 180°) in which an electrical connection between the terminal contacts 3A, 4A of the disconnect switch 3 and of the grounding switch 4 can be established so as to ground the busbar 7.

FIG. 1E shows a switching position (angle of rotation 270°) in which an electrical connection between the terminal contacts 2A, 3A, 4A of the power switch 2 or load disconnect switch, of the disconnect switch 3 and of the grounding switch 4 can be established so as to ground the cable outlet 8 and the busbar 7.

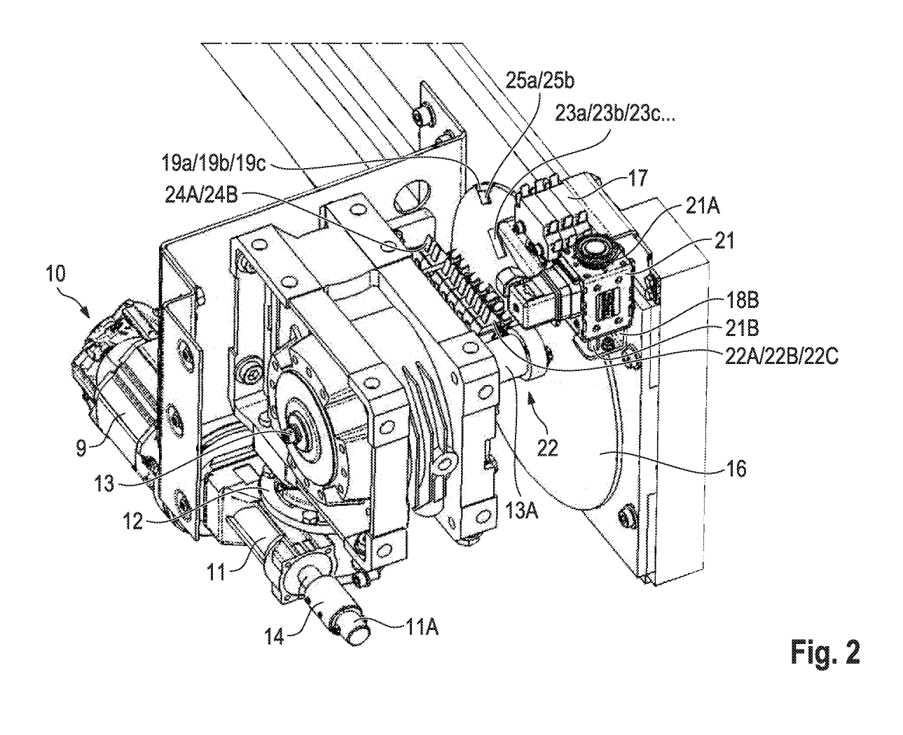

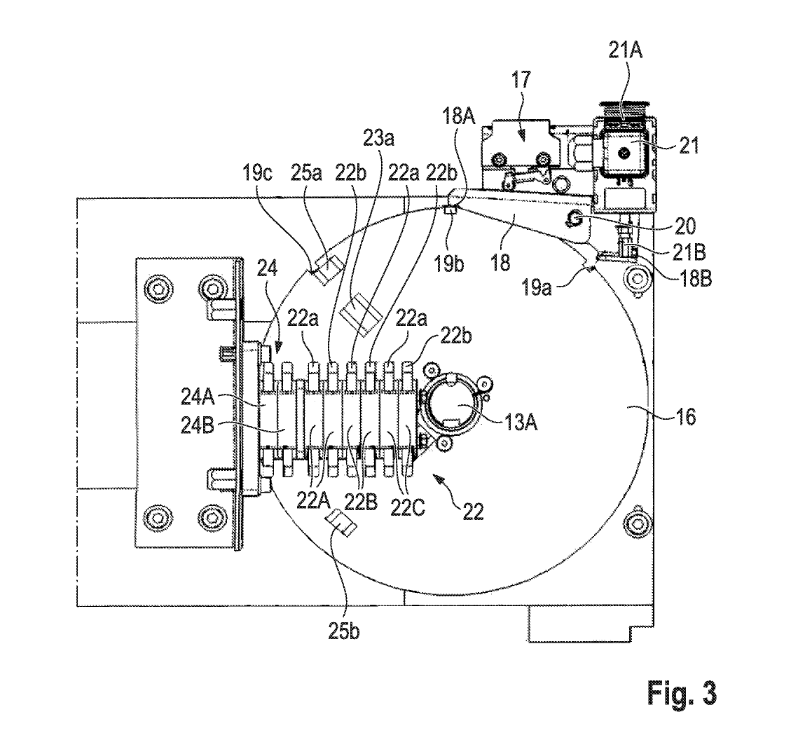

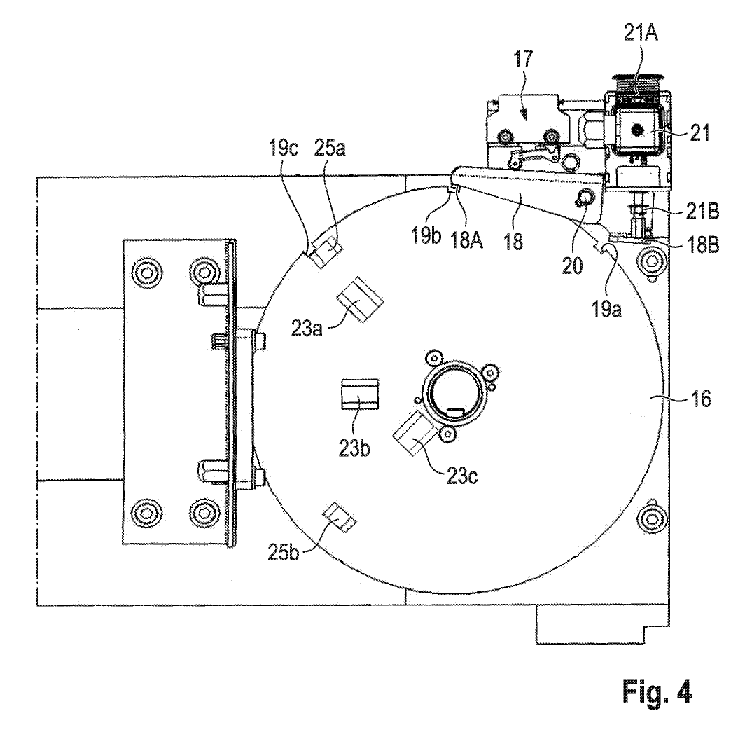

FIG. 2 is a perspective drawing of the drive unit 10 for rotating the rotary switch 1A of a first embodiment. This embodiment provides the switching positions shown in FIG. 1A to 1C (three-position switch). FIGS. 3 and 4 are partial views of the drive unit 10.

Hereinafter, only the parts of the drive unit 10 which are important to the invention are described. The drive unit 10 has a drive motor 9, which in the present embodiment is an electric motor. The drive train comprises a first transmission 11, the longitudinal axis of which is positioned in a horizontal plane on the axis of the motor 9, a second transmission 12, the longitudinal axis of which extends in a vertical plane perpendicular to the axis of the first transmission 11, and a third transmission 13, the longitudinal axis of which extends in a horizontal plane perpendicular to the axis of the second transmission 12. In this way, for motor voltages between 48 V DC and 220 V DC or AC, the relatively high torques of up to 600 Nm required for rotating the rotary switch can be produced at the transmission output. On a shaft 11A of the first transmission 11, a fixing piece 14 for a hand crank is provided so as to make manual operation possible.

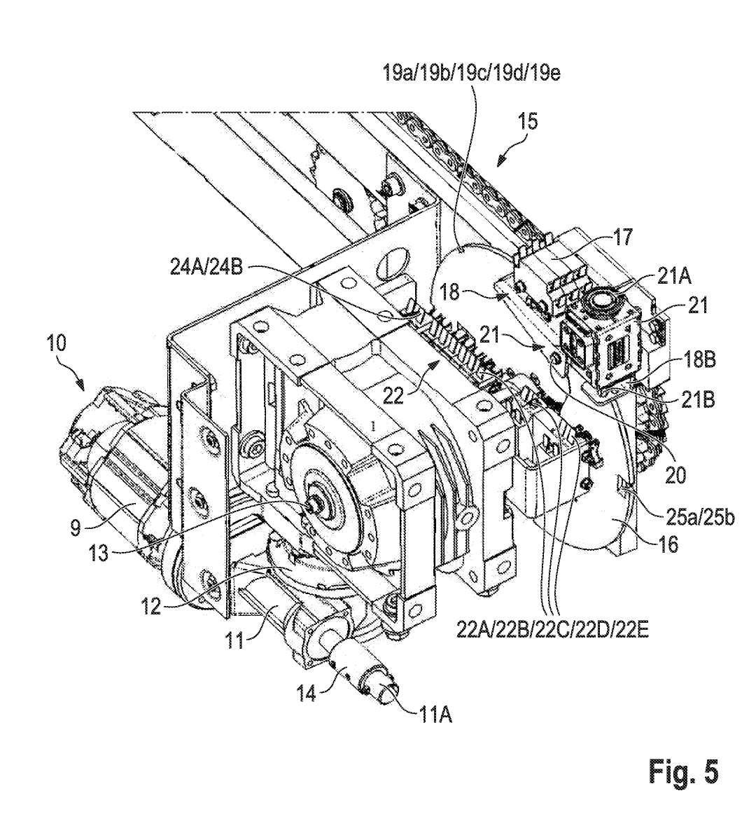

The switching unit 1 and the drive unit 10 are separate structural units, which are arranged physically close together. The driven shaft 13A of the third transmission 13 drives the central drive shaft 6 of the switching unit 1. In the present embodiment, the driven shaft 13A of the third transmission 13 is connected to the drive shaft 6 of the switching unit 1 via a traction drive 15, in particular a chain drive, which preferably has a transmission ratio of 1:1 (FIG. 5).

The drive unit 10 has an actuation unit for actuating the drive motor 9, which has a rotatable body 16 which is connected to the driven shaft 13A of the drive unit 10. The actuation unit may also be referred to as an actuator. In the present embodiment, the rotatable body is a disc 16. When the drive motor 9 rotates the driven shaft 13A along with the disc 16 through 360°, at the transition ratio of 1:1 the drive shaft 6 of the switching unit is likewise rotated through 360°, in such a way that the switching contact arrangement 5 also rotates through 360°. As a result, the position of the disc 16 exactly corresponds to the switching position of the rotary switch.

The actuation unit of the drive unit 10 has a switching member 17, which in the present embodiment is an electrical switch 17 for switching the electric motor 9 on and off. The switching member 17 may also be referred to as a motor switch. When the switch 17 is closed the drive motor 9 is switched on, and when the switch is open the drive motor is switched off. The switch 17, which may be a three-phase switch having a plurality of contact pairs, is activated by an activation element 18, which is formed as a latch which engages in recesses 19a to 19c which are provided circumferentially distributed on the circumferential face of the disc 16 in predetermined switching positions. The front portion of the activation element 18 has a shoulder 18A which engages in the recesses 19a to 19c, and the rear portion has a shoulder piece 18B. The central portion of the activation element 18 is mounted pivotably about a horizontal axis 20. Thus the activation element 18 may also be referred to as a pivoted lever. The positions of the recesses 19a to 19c on the circumference of the disc 16 correspond to the individual rotational positions of the switching contact arrangement 5 of the switching unit 1, in other words to the switching positions of the switching unit. Thus, for example, the recesses 19a and 19b are at an angle of 45°, and the recesses 19b and 19c are at an angle of 45°.

Furthermore, the actuation unit has a release unit 21, by means of which the activation element 18 can be pivoted about the axis 20 from the position in which the front shoulder 18A is engaged with the disc 16 into a position in which the front shoulder 18A is disengaged from the disc 16, in other words the latch is released. The release unit 21 has an electromagnetically operated drive 21A for a bolt 21B, which is guided displaceably in the longitudinal direction and which acts on the rear shoulder 18B of the activation element 18 in such a way that the activation element can be pivoted from the engagement position into the release position so as to activate the switch 17. In the engagement position, the switch 17 is open, in such a way that the circuit which includes the electric motor 9 is interrupted, whilst the switch 17 is closed in the release position in such a way that the motor 9 is switched on.

The control unit further has a control circuit (not shown), which may have electrical and electronic components, for example semiconductors or relays. To switch the switching unit 1 from one switching position into another switching position, for example from the operating position into the disconnect position, the actuation unit actuates the release unit 21 for a predetermined time interval, in such a way that the activation element 18 is released and the switch is closed, in such a way that the electric motor 9 is switched on. The disc 16 of the drive unit 10 and the switching contact arrangement 5 of the switching unit 1 rotate clockwise or anticlockwise, depending on the running direction of the motor 9, synchronously until the front shoulder 18A of the activation element 18 engages in the next recess 19a to 19c again. At this point in time, the motor 9 stops, since the desired switching position has been reached.

The predetermined time interval for the release of the activation element 18 is calculated in such a way that the bolt 21B is retracted before the shoulder 18A of the activation element 18 engages in the recess 19a to 19c of the next switching position. However, the control system may also provide that the time interval is calculated to be longer, for example that the activation element 18 is still being held in the release position when the next recess is reached, in such a way that the motor 9 is only stopped when the position after the next is reached. As a result, individual switching positions can be skipped.

For proper operation of the switching system, the actuation unit not only ensures that the individual switching positions are exactly set, but also prevents the possibility of unreliable switching positions being adopted.

Furthermore, the actuation unit has a position detection means 22 so as to be able to detect the individual switching positions. The position detection means 22 may also be referred to as a position detector. The position detection means 22 has a plurality of switching position sensor elements 22A, 22B, 22C. In the present embodiment, three switching position sensor elements 22A, 22B, 22C are arranged side by side in a horizontal plane on a side face of the disc 16. Recesses 23a, 23b, 23c are assigned to the switching position sensor elements 22A, 22B, 22C, and are provided on the opposite side of the disc 16 at a corresponding radius, in such a way that the sensor elements 22A, 22B, 22C can come into engagement with or are out of engagement with the recesses 23a, 23b, 23c as the disc rotates. The switching position sensor elements 22A, 22B, 22C may have resiliently biased rollers on which the disc can roll along. The sensor elements 22A, 22B, 22C activate electrical switches or are formed as electrical switches. Each sensor element 22A, 22B, 22C may also have a plurality of buttons or switches 22a, 22b, so as to increase the redundancy, in such a way that the rotational position of the disc 16 can be detected even if a button or switch fails. In the present embodiment, the sensor elements 22A, 22B, 22C each have two switches 22a, 22b or buttons, which are closed when both switches or buttons engage in the recess 23a, 23b, 23c. Otherwise, the switches are open. However, the motor control system may also provide that the switches 22a, 22b or buttons are open when both switches or buttons engage in the recess 23a, 23b, 23c and are closed otherwise.

The recesses 23a, 23b, 23c for the switching position sensor elements 22A, 22B, 22C are arranged on the disc 16 in such a way that the position of the switches (buttons) 22a, 22b when the switch 17 interrupts the motor circuit in the operational position, disconnect position or “grounded cable outlet” position reflects the associated circuit (operational position, disconnect position, “grounded cable outlet” position). The position of the switches (buttons) 22a, 22b (open or closed) corresponds to a coding for the rotational position of the disc 16 or for the switching position of the switching unit 1. The control circuit is configured in such a way that the position of the switch (button) is evaluated so as to detect the position of the disc 16.

To protect the drive means against faulty operation and in the event of a fault in the control system, compulsory interruption of the motor circuit is provided. If the disc 16 rotates past the desired switching position because the activation element 18 does not enter into engagement with the disc 16, the electric motor 9 is switched off automatically shortly after overshooting the desired switching position. For this purpose, the actuation unit has an end position switching means 24.

In the present embodiment, the end position switching means 24 has two end position sensor elements 24A, 24B, which are arranged alongside the switching position sensor elements 22A, 22B, 22C in the horizontal plane. The end position sensor elements 24A, 24B, which actuate electrical switches (buttons) or are formed as electrical switches, can engage in recesses 25a, 25b, which are provided on the opposite side face of the disc 16 at the corresponding radius. The recesses 25a, 25b for the end position sensor elements 24A, 24B are arranged in such a way that, immediately after the desired switching position is overshot, the relevant switch is activated. In the present embodiment, the switch is closed if the end position sensor element 24A, 24B does not engage in the corresponding recess 25a, 25b and is closed if the end position sensor element 24A, 24B engages in the recess 25a, 25b. In the embodiment, the switches are arranged in the circuit which includes the electric motor 9, in such a way that the circuit is interrupted and the motor is switched off if the end position sensor element 24A, 24B engages in the associated recess 25a, 25b after overshooting the desired switching position.

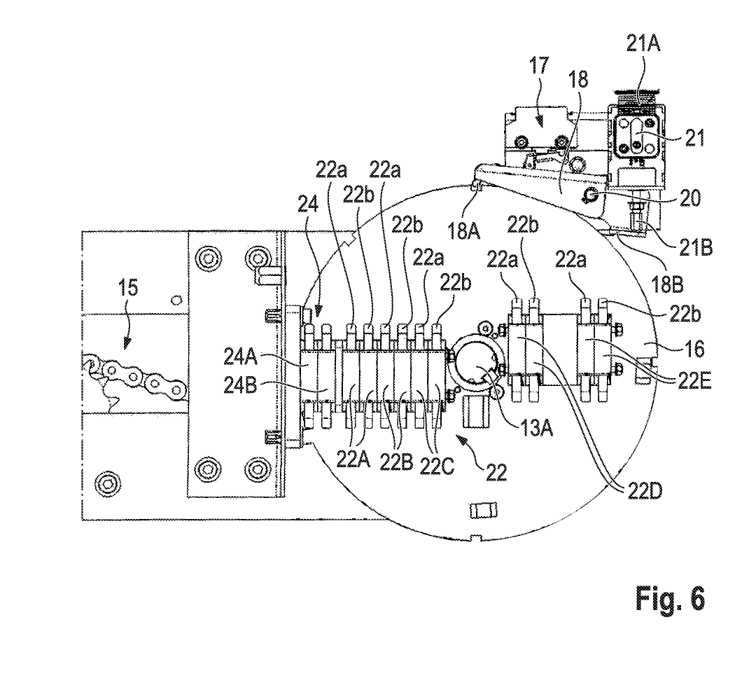

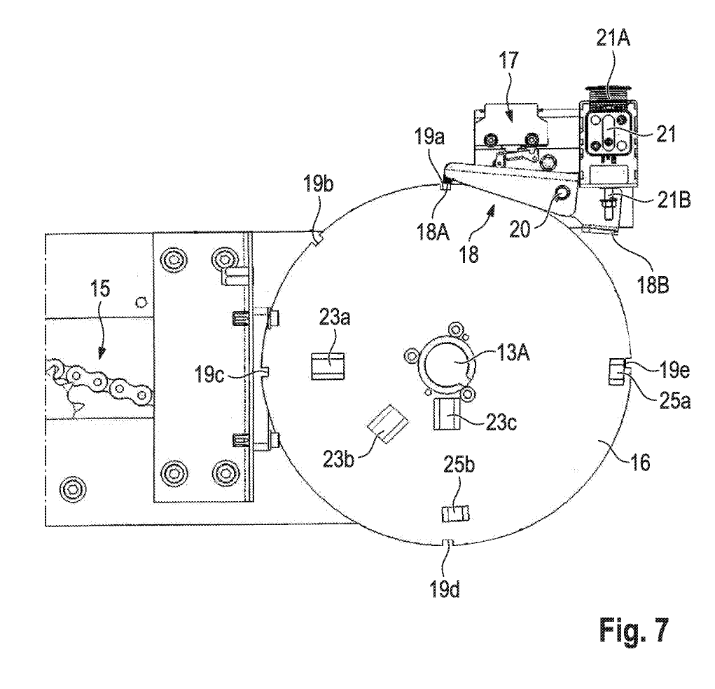

FIG. 5 is a perspective drawing of the drive unit 10 for rotating the rotary switch of a second embodiment. This embodiment also provides the switching positions shown in FIGS. 1D and 1E as well as the switching positions shown in FIG. 1A to 1C (five-position switch). FIGS. 6 and 7 are partial views of the drive unit 10. The parts of the alternative embodiment which correspond to those of the embodiment described with reference to FIGS. 2 to 4 are provided with the same reference numerals.

The alternative embodiment differs from the embodiment of FIGS. 2 to 4 in that, instead of three recesses 19a, 19b, 19c, two further recesses 19d, 19e are provided on the circumferential face of the disc 16 for the three switching positions, so as to be able to reproduce five switching positions. Furthermore, for detecting the additional switching positions, two further switching position sensor elements 22D, 22E are provided, which may each comprise two switches 22a, 22b (buttons).

When the “grounded busbar and cable outlet” position is reached, the activation element 18 falls into the recess 19e. Once the “grounded busbar” position is reached, the activation element falls into the recess 19d. The indications for the two additional positions are detected analogously to the case of the three-position switch, by way of the switching position sensor element 22D for the “grounded busbar and cable outlet” position and the switching position sensor element 22E for the “grounded busbar” position. In this context, the switching position sensor elements are activated and released from the recesses 23a, 23b, 23c for the position indications, as in the case of the three-position switch. The recesses 23a, 23b, 23c and the switching position sensor elements 22A, 22B are arranged in such a way that the three recesses 23a, 23b, 23c of the three-position switch on the side face of the disc 16 are sufficient for coding all of the switching positions. The basic functionalities and processes of the three-position switch are still maintained.

1-15. (canceled)

16: A high-voltage or medium-voltage switching system including at least one switching unit, the at least one switching unit comprising:
a rotary switch including a plurality of predetermined switching positions; and
a drive unit configured to rotate the rotary switch, the drive unit including:
a drive motor;
an actuation unit configured to actuate the drive motor such that the drive motor moves the rotary switch between the plurality of predetermined switching positions, the actuation unit including:
a switching member configured to switch the drive motor on and off;
a rotatable body;
an activation element configured to cooperate with the rotatable body to activate the switching member;
wherein the rotatable body is configured to have a plurality of predetermined rotational positions corresponding to the plurality of predetermined switching positions of the rotary switch; and
wherein when the rotatable body is in one of the predetermined rotational positions the activation element is in a first position of the activation element engaged with the rotatable body and the switching member is in a first switching state, and when the rotatable body is outside of the predetermined rotational positions the activation element is in a second position of the activation element disengaged from the rotatable body and the switching member is in a second switching state.

17: The high-voltage or medium-voltage switching system of 16, wherein:
the actuation unit includes a release unit configured to release the activation element by moving the activation element from a position in which the activation element is engaged with the rotatable body into a position in which the activation element is disengaged from the rotatable body.

18: The high-voltage or medium-voltage switching system of 17, wherein:
the activation element is pivotable about an axis; and
the release unit includes a bolt guided displaceably in a longitudinal direction such that the bolt acts on the activation element to pivot the activation element from the position in which the activation element is engaged with the rotatable body into the position in which the activation element is disengaged from the rotatable body.

19: The high-voltage or medium-voltage switching system of 18, wherein:
the actuation unit is configured such that to rotate the rotary switch from one position of the plurality of predetermined switching positions to another position of the plurality of predetermined switching positions:
the release unit is actuated causing the activation element to be disengaged from the rotatable body such that the drive motor is switched on; and
the rotary switch is rotated by the drive motor until the activation element comes into engagement with the rotatable body such that the drive motor is switched off.

20: The high-voltage or medium-voltage switching system of 16, wherein:
the drive motor is an electric motor; and
the switching member is an electrical switch configured to open and close a circuit including the drive motor.

21: The high-voltage or medium-voltage switching system of 16, wherein:
the rotatable body includes a disc positioned on a rotatable driven shaft of the drive unit.

22: The high-voltage or medium-voltage switching system of 21, wherein:
the disc includes a plurality of recesses circumferentially distributed on the disc; and
the activation element includes a latch configured to engage the recesses in the disc, the recesses corresponding to the predetermined rotational positions of the disc and to the predetermined switching positions of the rotary switch.

23: The high-voltage or medium-voltage switching system of 16, wherein:
the actuation unit includes a position detector including a plurality of switching position sensor elements; and
the rotatable body is configured such that in each of the predetermined rotational positions of the rotatable body at least one of the switching position sensor elements is engaged with the rotatable body depending on the rotational position of the rotatable body.

24: The high-voltage or medium-voltage switching system of 23, wherein:
the rotatable body includes a side face and a plurality of recesses circumferentially distributed on the side face; and
each of the switching position sensor elements is configured to engage a respective one of the plurality of recesses when the rotatable body is in a respective one of the plurality of predetermined rotational positions corresponding to a respective one of the plurality of predetermined switching positions of the rotary switch.

25: The high-voltage or medium-voltage switching system of 23, wherein:
the position detector includes a plurality of electrical switches or buttons configured to be actuated by the switching position sensor elements.

26: The high-voltage or medium-voltage switching system of 16, wherein:
the actuation unit includes at least one end position sensor element; and
the rotatable body is configured such that in a predetermined end position the at least one end position sensor element is engaged with the rotatable body.

27: The high-voltage or medium-voltage switching system of 26, wherein:
the rotatable body includes a side face and a plurality of recesses circumferentially distributed on the side face; and
the actuation unit includes switches or buttons configured to be activated by the at least one end position sensor element.

28: The high-voltage or medium-voltage switching system of 16, wherein:
the drive unit includes a driven shaft;
the rotary switch includes a drive shaft and a switch contact arrangement connected to the drive shaft to be rotatable about a central axis of the drive shaft; and
the at least one switching unit further includes a traction drive connecting the driven shaft of the drive unit to the drive shaft of the rotary switch.

29: The high-voltage or medium-voltage switching system of 16, wherein:
the rotary switch is configured such that in the plurality of predetermined rotational positions of the rotatable body corresponding to the plurality of predetermined switching positions of the rotary switch, electrical connections can be established between terminal contacts of two or more of a power switch, a disconnect switch and a grounding switch.

30: The high-voltage or medium-voltage switching system of 29, wherein the rotary switch is configured such that:
in one of the predetermined rotational positions of the rotatable body an electrical connection is established between the terminal contacts of the power switch and the grounding switch;
in another of the predetermined rotational positions of the rotatable body any electrical connections between the terminal contacts of the power switch, the disconnect switch and the grounding switch are interrupted; and
in another of the predetermined rotational positions of the rotatable body an electrical connection is established between the terminal contacts of the power switch and the disconnect switch.

31: The high-voltage or medium-voltage switching system of 30, wherein the rotary switch is configured such that:
in another of the predetermined rotational positions of the rotatable body an electrical connection is established between the terminal contacts of the disconnect switch and the grounding switch; and
in another of the predetermined rotational positions of the rotatable body an electrical connection is established between the terminal contacts of the power switch, the disconnect switch and the grounding switch.

32: A switch gear comprising:
a rotary switch including a plurality of predetermined switching positions;
a drive motor; and
an actuator configured to actuate the drive motor such that the drive motor moves the rotary switch between the plurality of predetermined switching positions, the actuator including:
a motor switch configured to switch the drive motor on and off;
a rotatable body;
an activation element configured to cooperate with the rotatable body to activate the motor switch;
wherein the rotatable body is configured to have a plurality of predetermined rotational positions corresponding to the plurality of predetermined switching positions of the rotary switch; and
wherein when the rotatable body is in one of the predetermined rotational positions the activation element is in a first position of the activation element engaged with the rotatable body and the motor switch is in a first switching state, and when the rotatable body is outside of the predetermined rotational positions the activation element is in a second position of the activation element disengaged from the rotatable body and the motor switch is in a second switching state.

33: The switch gear of claim 32, wherein:
the activation element includes a pivoted lever; and
the switch gear further includes a release actuator configured to pivot the pivoted lever from a position in which the pivoted lever is engaged with the rotatable body into a position in which the pivoted lever is disengaged from the rotatable body.

34: The switch gear of claim 33, wherein:
the rotatable body includes a plurality of recesses circumferentially distributed on the rotatable body; and
the pivoted lever includes a latch configured to engage the recesses in the rotatable body, the recesses corresponding to the predetermined rotational positions of the rotatable body and to the predetermined switching positions of the rotary switch.

35: The switch gear of claim 32, further comprising:
a position detector including a plurality of switching position sensor elements; and
wherein the rotatable body is configured such that in each of the predetermined rotational positions of the rotatable body at least one of the switching position sensor elements is engaged with the rotatable body depending on the rotational position of the rotatable body.
